(19) United States
(12) Patent Application Publication
(10) Pub. No.: US 2018/0081815 A1
(43) Pub. Date: Mar. 22, 2018

(54) WAY STORAGE OF NEXT CACHE LINE

(71) Applicant: QUALCOMM Incorporated, San Diego, CA (US)

(72) Inventors: Suresh Kumar VENKUMAHANTI, Austin, TX (US); Aditi GORE, Austin, TX (US); Stephen SHANNON, Austin, TX (US); Matthew CUMMINGS, Round Rock, TX (US)

(21) Appl. No.: 15/273,297

(22) Filed: Sep. 22, 2016

(51) Int. Cl. G06F 12/0864

(52) U.S. Cl. CPC G06F 12/0864; G06F 2212/6082; G06F 2212/6032; G06F 2212/1008

(57) ABSTRACT

Systems and methods for accessing a cache include determining if a current access of the cache will satisfy an expected relationship with a next access of the cache, wherein the cache is a set-associative cache comprising multiple ways. The next way for the next access is stored in a next way field associated with the current access. If the expected relationship will be satisfied, such as a sequential relationship which will be satisfied in the case of an instruction cache when the current access does not cause a change in control flow, the next way for the next access is retrieved from the next way field associated with the current access. The next way of the cache is then directly accessed using the retrieved next way.

### FIELD OF DISCLOSURE

Disclosed aspects are directed to cache memories in processing systems. More specifically, exemplary aspects are directed to improving efficiency and reducing power consumption of caches.

### BACKGROUND

A processing system may generally comprise a processor and a memory system comprising one or more levels of cache memories, or simply, caches. The caches are designed to be small, high speed storage mechanisms for storing data which is determined to have likelihood of future use for the processor. If the requested data is present in the cache, a cache hit results and the data can be read directly from the cache which produced the cache hit, resulting in a high speed operation. On the other hand, if the requested data is not present in the cache, a cache miss results, and backing storage locations such as other caches or ultimately the memory may be accessed to retrieve the requested data, which may incur significant time delays. The caches may include data caches, instruction caches, or a combination thereof.

Various cache architectures are known in the art. For example, in a direct mapped cache, each cache entry can only be stored in one location, and thus, while locating a cache entry may be easy, the hit rate may be low. In a fully associative cache, a cache entry can go anywhere in the cache, which means that the hit rate may be high, but it may take longer to locate a cache entry.

A set-associative cache offers a compromise between the above two replacement policies. In a set-associative cache, the cached data is stored in a data array comprising multiple sets and within each set, a cache entry or cache line of the cached data can be located in one of several places, referred to as “ways”. A tag array is maintained in conjunction with the data array of the set-associative cache. The tag array comprises tags associated with each cache line, wherein the tags include at least a subset of bits of memory addresses of the associated cache lines.

In a process of searching the set-associative cache to determine whether a cache line is present in the data array of the set-associative cache, an index, which may be derived from another subset of bits of a memory address of the cache line, is used to locate a set which may possibly contain the cache line. A search tag formed using the memory address of the cache line is then compared with the tags of all cache lines in the multiple ways of the set. If there is a matching tag which matches the search tag in one of the ways, then there is a cache hit and the cache line corresponding to the matching tag is accessed; if none of the ways have a tag which matches the search tag, then there is a cache miss.

In conventional implementations, the search through the multiple ways of a set for determining whether there is a hit or a miss is conducted in parallel. This involves reading out from the tag array, the tags for all the cache lines in the multiple ways of the set, and comparing each of the tags with the search tag to determine whether there is a hit. In parallel, all the cache lines in the multiple ways of the set, are also read out from the data array, and if there is a hit, then the cache line for which there was a hit is selected. Correspondingly, there is significant power consumption in the search process, both for the tag array read and comparison of the multiple tags with the search tag, as well as for the data array read of the multiple cache lines and subsequent selection of the hitting cache line (keeping in mind that the cache lines in the data array may be of large sizes, e.g., 256-bits wide).

Some approaches for reducing the above power consumption involve complex way prediction mechanisms for predicting the particular way of the set that may yield a matching tag. For example, some known approaches maintain a trace cache which stores a trace or history of all prior cache accesses along with the ways associated with each cache line, with the notion that cache accesses are likely to follow repeated patterns. In these approaches, if it is determined that a sequence of cache accesses follow a pattern which is stored in the trace cache, then the corresponding ways for the cache accesses are read out from the stored ways and used as way predictions for accessing the set-associative cache. However, trace caches themselves are very expensive in terms of area and power, and the associated costs increase with the amount of history stored in the trace caches. Thus, any power savings which may be realized by using the way prediction to avoid searching through multiple ways may be offset by the costs associated with implementing the trace cache.

Therefore, there is a corresponding need in the art for reducing the power consumption of multi-way set-associative caches without incurring the drawbacks of the aforementioned conventional approaches.

### SUMMARY

Exemplary aspects of the invention are directed to systems and method for accessing a cache include determining if a current access of the cache will satisfy an expected relationship with a next access of the cache, wherein the cache is a set-associative cache comprising multiple ways. The next way for the next access is stored in a next way field associated with the current access. If the expected relationship will be satisfied, such as a sequential relationship which will be satisfied in the case of an instruction cache when the current access does not cause a change in control flow, the next way for the next access is retrieved from the next way field associated with the current access. The next way of the cache is then directly accessed using the retrieved next way.

For example, an exemplary aspect is directed to a method of cache access, the method comprising determining if a current access of a cache will satisfy an expected relationship with a next access of the cache, wherein the cache is a set-associative cache comprising multiple ways. If the expected relationship will be satisfied, a next way is retrieved for the next access from a next way field associated with the current access; and the next way is directly accessed for the next access.

Another exemplary aspect is directed to an apparatus comprising a cache, wherein the cache is set-associative and comprises multiple ways per set. The apparatus includes logic configured to determine if a current access of the cache will satisfy an expected relationship with a next access of the cache, a next way field associated with the current access, the next way field configured to provide a next way for the next access if the expected relationship will be satisfied, and logic configured to directly access the next way for the next access.

Yet another exemplary aspect is directed to an apparatus comprising a cache, wherein the cache is set-associative and comprises multiple ways per set. The apparatus includes means for associating, with a current access of the cache, an indication of a next way for a next access of the cache, means for determining if the current access will satisfy an expected relationship with the next access, means for obtaining the indication of the next way if the expected relationship will be satisfied, and means for directly accessing the next way for the next access.

### BRIEF DESCRIPTION OF THE DRAWINGS

The accompanying drawings are presented to aid in the description of aspects of the invention and are provided solely for illustration of the aspects and not limitation thereof.

FIG. 1 depicts an exemplary processing system comprising a set-associative cache, configured according to aspects of this disclosure.

FIG. 2 illustrates an example code sequence to illustrate cache access, according to aspects of this disclosure

FIG. 3 illustrates aspects of a set-associative cache, according to aspects of this disclosure.

FIG. 4 depict an exemplary method for cache access according to aspects of this disclosure.

FIG. 5 depicts an exemplary computing device in which an aspect of the disclosure may be advantageously employed.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Exemplary aspects of this disclosure are directed to reducing power consumption in processing systems, and specifically, the power consumed in accessing multi-way set-associative caches. In one aspect, the way of a next cache line to be accessed is stored in the tag of a current cache line. If the relationship of the next cache line and the current cache line satisfy an expected relationship (e.g., they are sequential, per the example below), then the next cache line is accessed using the stored way, which avoids the need for comparing a tag of the next cache line with tags of multiple ways and reduces power correspondingly.

For example, considering an instruction cache configured to store instructions to be executed by a processor, a sequential relationship is generally observed between one instruction and the next in a program (e.g., they have sequential program counter (PC) values), unless there is a change in control flow. A change in control flow can occur if a branch instruction is taken, for example, and the target of the branch instruction is a different instruction than the next sequential instruction. If there is no such change in control flow, then the current instruction and the next instruction are expected to have a sequential relationship. In pipelined implementations of processor architectures, at the time of fetching a current instruction, it will be known whether the next instruction is the next sequential instruction as expected, and if so, a next way for the next sequential instruction which is stored along with a current tag of the current instruction is read out and directly used for accessing the instruction cache for the next instruction.

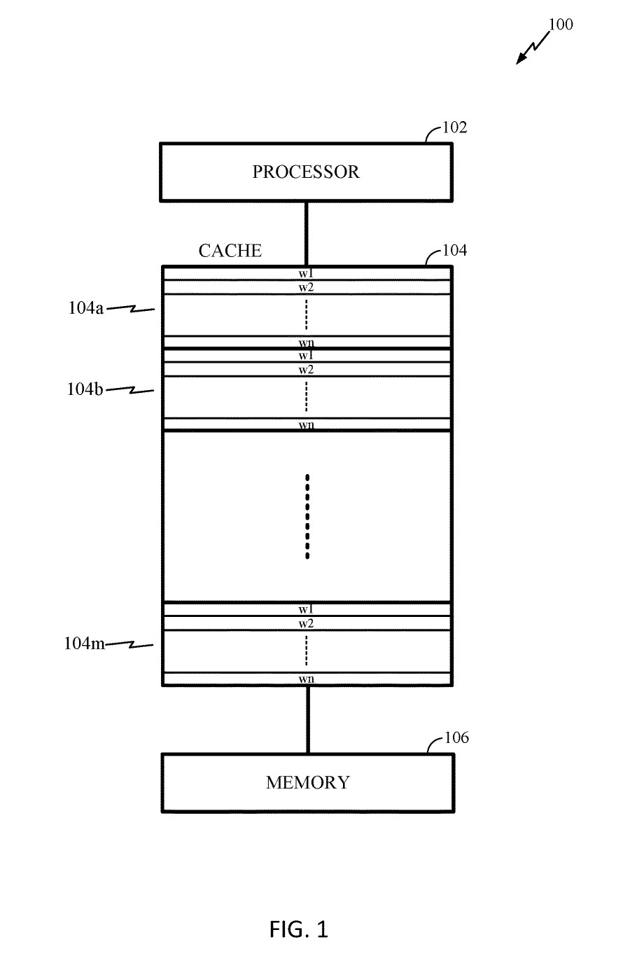

With reference to FIG. 1, exemplary processing system 100 is illustrated with processor 102, cache 104, and memory 106 representatively shown, keeping in mind that various other components which may be present have not been illustrated for the sake of clarity. Processor 102 may be any processing element configured to make memory access requests to memory 106 which may be a main memory (e.g., a dynamic random access memory or “DRAM”). Cache 104 may be one of several caches present in between processor 102 and memory 106 is a memory hierarchy of processing system 100.

In one example, cache 104 may be an instruction cache designed as a set associative cache with multiple-ways. Specifically, cache 104 has been shown to comprise m sets 104a-m, with each set comprising n ways w1-n of cache lines, wherein each cache line may hold an instruction. Although not separately illustrated in FIG. 1, a tag array is associated with cache 104 to hold tags for each one of the illustrated cache lines. In an example, if processor 102 is executing instructions supplied by cache 104, then each instruction is accessed from a cache line of cache 104 using an associated address of the cache line. A first subset of bits of the address (e.g., low order bits) may form an index to point to one of sets 104a-m which may comprise the instruction and a second subset of bits of the address (e.g., higher order bits) may form a tag. Assuming there is a hit in cache 104, the way of the indexed set whose tag matches the tag derived from the instruction's address comprises the instruction, and the instruction can be read out from that way.

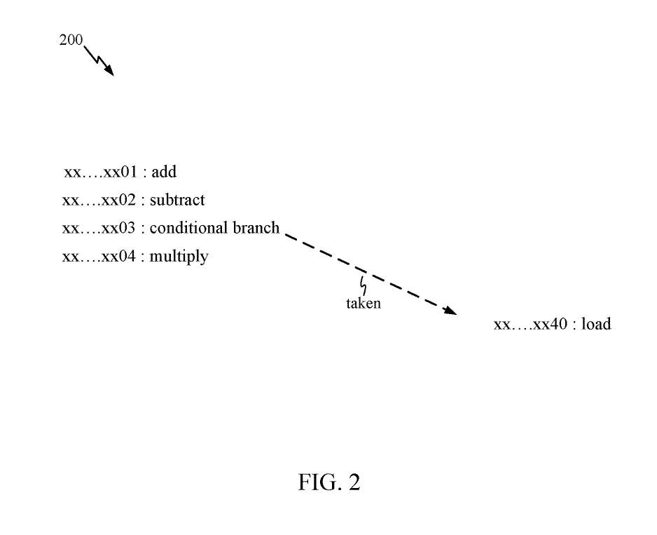

For example, with reference to FIG. 2 an example code 200 which may comprise instructions executed by processor 102 is illustrated. For the sake of simplicity, example addresses for cache lines which hold the instructions in code 200 have been shown in decimal notation. Code 200 starts with a first address (address xx . . . xx01) corresponding to a first cache line which comprises a first instruction (add); a second address (address xx . . . xx02) corresponding to a second cache line which comprises a second instruction (subtract); a third address (address xx . . . xx03) corresponding to a third cache line which comprises a third instruction (conditional branch); a fourth address (address xx . . . xx04) corresponding to a fourth cache line which comprises a fourth instruction (multiply); and a fifth address (address xx . . . xx40) corresponding to a fifth cache line which comprises a fifth instruction (load).

In one aspect, with combined reference to FIGS. 1-2, the above-mentioned five instructions may be stored in any of the m sets 104a-m in any of the n ways w1-n within respective sets of cache 104. Corresponding tags formed from respective addresses of the each of the five cache lines comprising the five instructions may be stored in respective tag arrays. In addition, exemplary aspects may also comprise a next way field stored along with the tags in the tag array, the next way field comprising the way of the next sequential access. For example, along with a first tag for the first cache line comprising the first instruction (add), formed by a subset of bits of the first address, a way for the second cache line comprising the second instruction (subtract) may be stored in a first next way field. Similarly, along with a second tag for the second cache line comprising the second instruction, in a second next way field, the way for the third cache line comprising the third instruction (conditional branch) may be stored; and along with a third tag for the third cache line comprising the third instruction, in a third next way field, the way for the fourth cache line comprising the fourth instruction (multiply) may be stored.

In the case of the first instruction (add), execution of the first instruction does not cause a change in control flow, so there is a sequential relationship with the next instruction, i.e., the second instruction (subtract). In a pipelined execution of code 200 by processor 102, the first instruction may be retrieved first from the first cache line of cache 104 (e.g., from a way of any one of sets 104a-m, wherein the way for the first cache line may be determined in a conventional manner since it comprises the starting instruction of code 200 for the sake of this discussion). At the time of retrieving the first cache line comprising the first instruction, the first next way field is also read out along with the first tag. The first next way field comprises the second way for the second cache line comprising the second instruction. Thus, at the time of accessing the second cache line comprising the second instruction, the corresponding second way is already known, and the second way is directly read out from a corresponding set 104a-m of cache 104.

The second instruction (subtract) also does not cause a change in control flow and so the second and third instructions also similarly share a sequential relationship. Accordingly, in similar manner as above, when reading out the second cache line comprising the second instruction, the second next way field is accessed to retrieve the third way, and third cache line comprising the third instruction is retrieved from the third way of a corresponding set 104a-m of cache 104.

However, the third instruction is a conditional branch instruction, which can cause a change in control flow if the conditional branch instruction resolves in the taken direction to change control flow of code 200 to the fifth instruction, rather than follow a not-taken sequential path to the expected next sequential instruction, the fourth instruction. Thus, in this case, if the conditional branch instruction resolves in the taken direction, then the third next way field does not help in determining the way of the next cache line comprising the next instruction accessed from cache 104, i.e., the fifth cache line comprising the fifth instruction. Accordingly, for accessing cache 104 to retrieve the fifth cache line comprising the fifth instruction, conventional techniques may be resorted to, for searching through all n ways of a set indexed by the fifth address and retrieving the fifth cache line comprising the fifth instruction from a way whose tag matches the fifth tag formed from a subset of bits of the fifth address.

On the other hand, if the conditional branch instruction resolves in the not taken-direction, then when accessing the third instruction, the third next way field is read to retrieve the fourth way corresponding to the fourth cache line comprising the fourth instruction (the expected next sequential instruction) and the fourth cache line comprising the fourth instruction is read directly from the retrieved fourth way of a corresponding set of cache 104.

Accordingly, it is seen that in exemplary aspects, the relationship between a current cache line (e.g., corresponding to the current access or comprising the current instruction) and the next cache line (e.g., corresponding to the next access or comprising the next instruction) is determined, and if the relationship satisfies an expected relationship (e.g., the next instruction and the current instruction are sequential), the next way for the next cache line is retrieved from a next way field stored along with a current tag of the current cache line and the next cache line is directly retrieved from the next way, avoiding searching through a tag array and related power consumption.

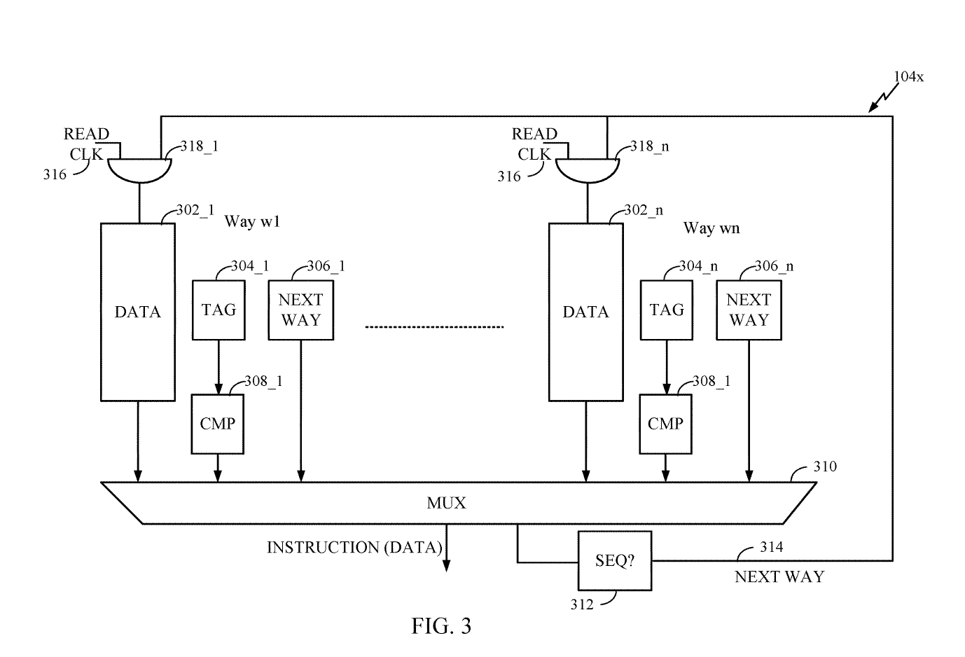

With reference to FIG. 3, an example implementation of the above-described aspects is shown for an example set 104x of cache 104. Within set 104x, are shown the n ways, w1-wn which comprise the corresponding cache lines shown as data 302_1-302_n which may be stored in a data array (in the above examples where cache 104 is an instruction cache, the data corresponds to the instructions). For each of the cache lines data 302_1-302_n in the n ways, corresponding tags 304_1-304_n are also shown, which may be stored in a structure such as a tag array. As previously discussed, tags 304_1-304_n comprise a subset (e.g., higher order or more significant bits) of addresses of the respective data 302_1-302_n stored in ways w1-wn. Furthermore, along with tags 304_1-304_n, next way fields 306_1-306_n are also illustrated.

Block 312 comprises logic to determine, pursuant to a current access of one of ways w1-wn of set 104x, whether the next access would be sequential. If the next access is determined to be sequential, then the respective next way field 306_1-306_n is read out, channeled through the multiplexer shown as mux 310, and provided as next way 314. For example, with combined reference to FIG. 2, the current access may be for the first instruction which may have been stored as data 302_1 in way w1 in an example. Block 312 may check if the current access may cause a change in control flow (e.g., based on the operation code of the instruction corresponding to the current access). Since the first instruction (add) does not cause change in control flow, the next way or the second way for the next instruction, i.e., the second instruction (subtract), which would be retrieved from next way field 306_1 when reading tag 304_1 of the first instruction, will be provided as next way 314. The next way, in this case, the second way can be way wn, in an example. It is noted that if the way for an access is not known (e.g., the first time the first instruction is encountered, the second way may not be known), then the corresponding next way field is updated or allocated following the way determination in a conventional manner.

From the perspective of the next instruction, (the second instruction, following the above example), since the next way 314 is determined as the second way (wn) by block 312 as for the second instruction, the second instruction can be directly retrieved from data 302_n in way wn and channeled through mux 310, to be provided as the next instruction. In this regard, tags of the one or more remaining ways need not be searched, and such, the remaining ways, w2-wn may be turned off or gated with read clock 316. Gating logic such as AND gates 318_1-318_n may be used to gate off ways which are not being accessed by gating them with read clock 316, to further reduce power when it is known in advance that certain ways will not be used for a cache access.

Furthermore, although not shown, a valid field may also be maintained alongside the next way fields to indicate whether respective next way fields hold valid information. The valid field may be set when the next cache line is fetched and its way is known and verified to correspond to the value in the next way field. When the next cache line pointed to by the next way field is evicted from cache 104, for example, the valid field may be cleared.

If next way 314 is not available, e.g., not generated by block 312, then the tag for a current access may be compared with each one of tags 304_1-304_n, in respective compare blocks 308_1-308_n, for example, to determine the correct way. For example, if the third instruction, conditional branch instruction of code 200 resolves as taken, then the third next way field of the third instruction would not provide a valid next way field for the next instruction access, which would mean that for the next instruction, i.e., the fifth instruction (load) in this case, tag comparison may need to performed in the above-described manner with each one of ways w1-wn to determine the correct way which holds the fifth instruction.

It will be understood that the next way fields 306_1-306_n may provide way information for the next sequential access which may be directed to any set (e.g., the same set as the current set or a different set), and thus, not necessarily confined to set 104x. The set information may be retrieved in a conventional manner, e.g., using lower order or less significant bits of the addresses for the next cache access whose next way is determined according to the above exemplary aspects.

It will also be appreciated that the addition of next way fields 306_1-306_n (and accompanying valid fields) may not contribute to a significant addition in size and area. In example implementations, next way fields 306_1-306_n may hold a relatively small number of bits to represent an encoding of one of several possible ways (e.g., 3-bits to represent one of eight possible ways in an 8-way set-associative cache). Thus, the next way fields 306_1-306_n provide an efficient and low cost structure for determining the way for the next cache access (when the next cache access satisfies the expected relationship, e.g., is sequential), thus leading to power savings. Further, since the correct way for the next cache access can be determined in this manner, the remaining ways may be used for other cache accesses, such as, to enable multiple cache reads, multiple cache writes, simultaneous cache read and write to different ways, etc.

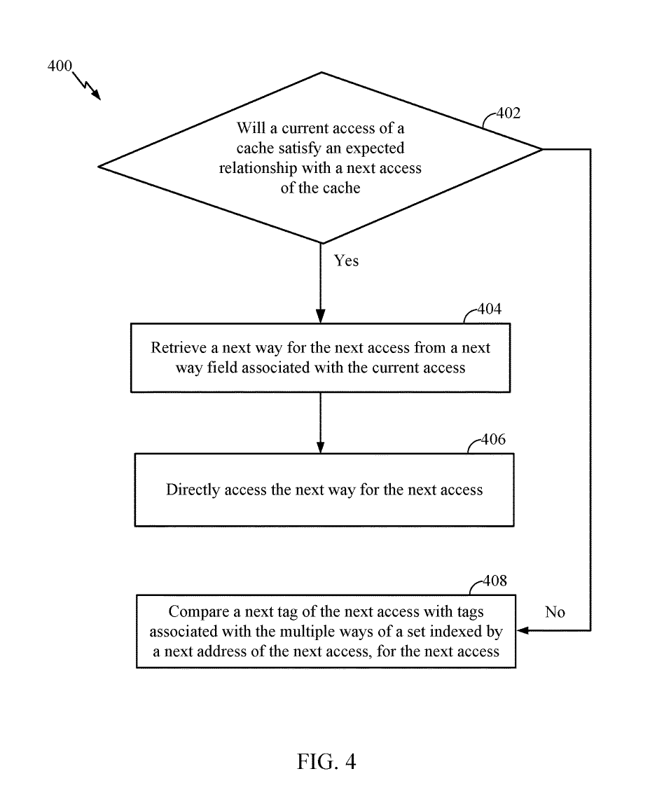

Accordingly, it will be appreciated that exemplary aspects include various methods for performing the processes, functions and/or algorithms disclosed herein. For example, FIG. 4 illustrates a method 400 of cache access (e.g., accessing cache 104 as discussed with respect to FIGS. 1-3) wherein the cache is a set-associative cache comprising multiple ways (e.g., cache 104 comprising m sets 104a-m, each set comprising n ways w1-wn).

In decision Block 402, method 400 comprises determining if a current access of a cache (e.g., access of cache 104 for the first instruction of FIG. 2 will satisfy an expected relationship (e.g., a sequential relationship) with a next access of the cache (e.g., for the second instruction). In one aspect, this determination may be made in block 312 of FIG. 3 as previously described.

In decision Block 402, if it is determined that the expected relationship will be satisfied, then method 400 proceeds to Block 404 for retrieving a next way (e.g., the second way) for the next access from a next way field associated with the current access (e.g., next way 314 determined from the next way field 306_1-n associated with a tag 304_1-n for data 302_1-n corresponding to the first instruction). Otherwise, method 400 proceeds to Block 408 comprising comparing a next tag of the next access with tags associated with the multiple ways of a set indexed by a next address of the next access, for performing the next access (e.g., comparing in compare blocks 308_1-n, the second tag derived from the second address for determining whether there is a matching way for the second instruction).

In Block 408, method 400 comprises directly accessing the next way for the next access (e.g., using next way 314 determined by block 312, and further, turning off remaining ways other than the next way 314, during the next access using AND gates 318_1-n and read clock 316 as discussed with relation to FIG. 3).

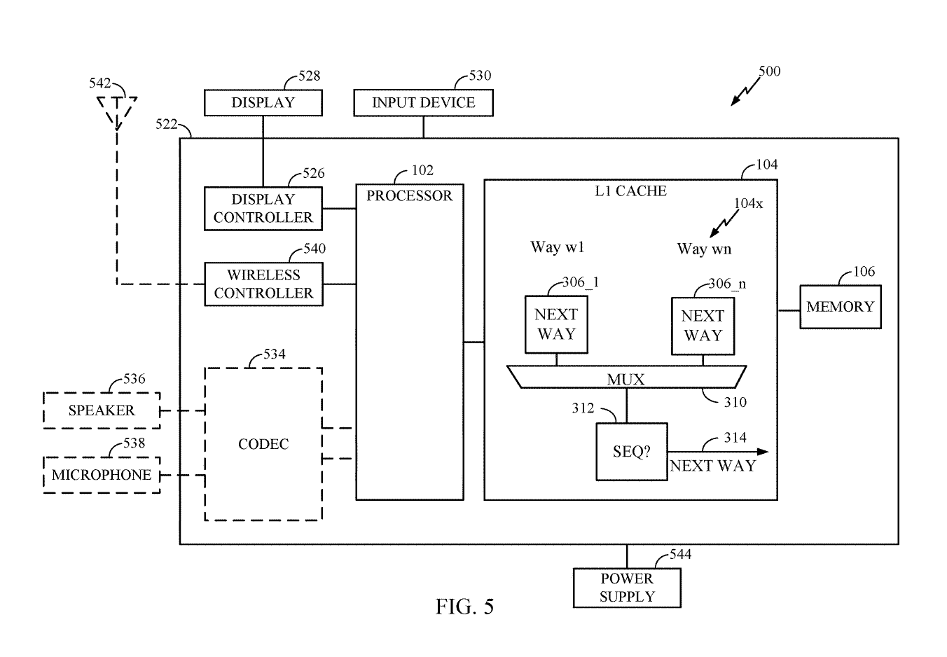

An example apparatus in which exemplary aspects of this disclosure may be utilized, will now be discussed in relation to FIG. 5. FIG. 5 shows a block diagram of computing device 500. Computing device 500 may correspond to an exemplary implementation of a processing system configured to perform method 400 of FIG. 4, for example. In the depiction of FIG. 5, computing device 500 is shown to include processor 102 and cache 104 shown in FIG. 1, wherein cache 104 is a set-associative configured for cache access as discussed herein. Some aspects of set 104x of cache 104 which were shown in FIG. 3, such as next way fields 306_1-n for ways w1-wn, mux 310, block 312 and next way 314 have been shown in FIG. 5, while additional details which were shown in FIG. 3 have been omitted in FIG. 5 for the sake of clarity. In FIG. 4, processor 102 is exemplarily shown to be coupled to memory 106 with cache 104 between processor 102 and memory 106 as described with reference to FIG. 1, but it will be understood that other memory configurations known in the art may also be supported by computing device 500.

FIG. 5 also shows display controller 526 that is coupled to processor 102 and to display 528. In some cases, computing device 500 may be used for wireless communication and FIG. 5 also shows optional blocks in dashed lines, such as coder/decoder (CODEC) 534 (e.g., an audio and/or voice CODEC) coupled to processor 102 and speaker 536 and microphone 538 can be coupled to CODEC 534; and wireless antenna 542 coupled to wireless controller 540 which is coupled to processor 102. Where one or more of these optional blocks are present, in a particular aspect, processor 102, display controller 526, memory 106, and wireless controller 540 are included in a system-in-package or system-on-chip device 522.

Accordingly, a particular aspect, input device 530 and power supply 544 are coupled to the system-on-chip device 522. Moreover, in a particular aspect, as illustrated in FIG. 5, where one or more optional blocks are present, display 528, input device 530, speaker 536, microphone 538, wireless antenna 542, and power supply 544 are external to the system-on-chip device 522. However, each of display 528, input device 530, speaker 536, microphone 538, wireless antenna 542, and power supply 544 can be coupled to a component of the system-on-chip device 522, such as an interface or a controller.

It should be noted that although FIG. 5 generally depicts a computing device, processor 102 and memory 106, may also be integrated into a set top box, a music player, a video player, an entertainment unit, a navigation device, a server, a personal digital assistant (PDA), a fixed location data unit, a computer, a laptop, a tablet, a communications device, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer readable media embodying a method for cache replacement. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of cache access, the method comprising:
determining if a current access of a cache will satisfy an expected relationship with a next access of the cache, wherein the cache is a set-associative cache comprising multiple ways;
if the expected relationship will be satisfied, retrieving a next way for the next access from a next way field associated with the current access; and
directly accessing the next way for the next access.

2. The method of claim 1, wherein the cache is an instruction cache and the expected relationship is a sequential relationship.

3. The method of claim 2, comprising determining that the sequential relationship will be satisfied if the current access does not cause a change in control flow.

4. The method of claim 1, comprising storing the next way field along with a current tag for the current access.

5. The method of claim 1, comprising turning off remaining ways of the multiple ways and enabling only the next way during the next access.

6. The method of claim 5, comprising gating the remaining ways with a read clock.

7. The method of claim 1, wherein if the expected relationship will not be satisfied, comparing a next tag of the next access with tags associated with the multiple ways of a set indexed by a next address of the next access, for performing the next access.

8. The method of claim 1, comprising associating a valid bit with the next way field to indicate that the next way is valid.

9. The method of claim 8, comprising clearing the valid bit upon eviction of the next way from the cache.

10. The method of claim 1, comprising performing another access on one or more remaining ways of the multiple ways during the next access of the next way.

11. The method of claim 1, wherein the current access and the next access are directed to same sets or different sets of the cache.

12. An apparatus comprising:
a cache, wherein the cache is set-associative and comprises multiple ways per set;
logic configured to determine if a current access of the cache will satisfy an expected relationship with a next access of the cache;
a next way field associated with the current access, the next way field configured to provide a next way for the next access if the expected relationship will be satisfied; and
logic configured to directly access the next way for the next access.

13. The apparatus of claim 12, wherein the cache is an instruction cache and the expected relationship is a sequential relationship.

14. The apparatus of claim 13, comprising logic configured to determine that the sequential relationship will be satisfied if the current access does not cause a change in control flow.

15. The apparatus of claim 12, wherein the next way field is stored along with a current tag for the current access.

16. The apparatus of claim 12, comprising gating logic configured to turn off remaining ways of the multiple ways and enable only the next way during the next access.

17. The apparatus of claim 16, further comprising a valid bit associated with the next way field to indicate that the next way is valid.

18. The apparatus of claim 17, wherein the valid bit is cleared upon eviction of the next way from the cache.

19. An apparatus comprising:
a cache, wherein the cache is set-associative and comprises multiple ways per set;
means for associating, with a current access of the cache, an indication of a next way for a next access of the cache;
means for determining if the current access will satisfy an expected relationship with the next access;
means for obtaining the indication of the next way if the expected relationship will be satisfied; and
means for directly accessing the next way for the next access.

20. The apparatus of claim 19, wherein the cache is an instruction cache and the expected relationship is a sequential relationship.
